(19) United States
(12) Patent Application Publication
(10) Pub. No.: US 2005/0289296 A1
(43) Pub. Date: Dec. 29, 2005

(54) SAN based application recognition (SBAR) for RAID controller

(76) Inventor: Sridhar Balasubramanian, Wichita, KS (US)

Correspondence Address: LSI LOGIC CORPORATION, 1621 BARBER LANE, MS: D-106, MILPITAS, CA, 95035, US

(21) Appl. No.: 10/876,192

(22) Filed: Jun. 23, 2004

(51) Int. Cl. G06F 12/00

(52) U.S. Cl. 711/114; 711/170

(57) ABSTRACT

An SBAR is established as a computer readable set of instructions that provide the ability to select the desired application by the end-user of a storage array. Based on the selected application, the SBAR automatically establishes an optimized pre-determined configuration profile for the storage array. The configuration profile comprises parameter settings of the storage array which optimize the performance of the application.

### FIELD OF THE INVENTION

The present invention generally relates to the field of storage arrays, and particularly to providing capabilities to a controller of the storage array which allow for the recognition of end user applications and configuring of the storage array automatically for optimum performance.

### BACKGROUND OF THE INVENTION

It is common to store large amounts of data on storage arrays, such as a Storage Area Network (SAN), which utilize non-volatile mass storage devices, such as magnetic or optical disks configured as Redundant Array of Inexpensive Disks (RAID). These storage arrays handle valuable or irreplaceable data and enable users to perform one or multiple applications utilizing the data. Data maintained by these storage arrays may be of vital importance, for example, in business application such as airline reservations, bank account management, electronic fund transfers, shipping and receiving, inventory control, and the like.

Interaction with the data in these storage arrays is often via a controller, such as a RAID controller, which provide access to the data governed by the parameters of the storage array. The diversity of the applications and the configuration complexity in a SAN environment has presented a number of challenges in optimizing the performance of a given SAN application. Recent trends in the storage industry have attempted to address this problem through various optimization techniques employed within the RAID controllers directed towards single, specific SAN application(s). Unfortunately, these techniques may have limited effectiveness due to limitations in their ability to optimize the performance of the RAID controller for only single, specific, pre-determined SAN applications.

Therefore, it would be desirable to provide a storage system capable of configuring the storage system parameters for yielding optimal performance for any number of given applications based on recognition of the application being performed.

### SUMMARY OF THE INVENTION

Accordingly, the present invention provides a storage area network based application recognition (SBAR) which recognizes an end-user selected application and configures the storage array parameters to provide the best performance of the application. In an aspect of the present invention, the SBAR may be established as a computer readable set of instructions which enables the detection of an application selected by an end-user of a storage array. Based on the detected application the SBAR establishes a configuration profile of the storage array. The configuration profile comprises parameter settings of the storage array which optimize the performance of the application.

In another aspect of the present invention, the computer readable set of instructions which comprise the SBAR may be established upon a computer readable medium housed within an enclosure. The enclosure may be established as hardware within a storage array environment which communicatively couples the SBAR with an array controller. In the alternative the SBAR enclosure may be established remotely from the internal hardware environment of the storage array. Communication between the remote SBAR enclosure and the storage array may be established using fibre channel protocols or various other communication technologies.

In a third aspect of the present invention, a method of optimizing the performance of an application from a storage array is provided. The first step is the detection of the application, which is selected by a user of the storage array. Following the detection of the application, storage array parameters are configured for optimizing performance of the application. The method may further comprise a step of generating a feature key, which enables the execution of the present invention upon the storage array.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is block diagram illustrating a method of array controller performance optimization by configuring a storage array for the performance of an application in accordance with an exemplary embodiment of the present invention;

FIG. 2 is an illustration of an exemplary storage area network (SAN) environment employing at least one graphical user interface communicatively coupled with an array controller of a storage array wherein the performance of an application is optimized by a method of array controller performance optimization by configuring the storage array for the performance of the application in accordance with an exemplary embodiment of the present invention;

FIG. 3 is a block diagram of an array controller including a SAN based application recognition (SBAR) component, for optimizing application performance, embedded within the subsystem for optimizing the performance of an application;

FIG. 4 is a block diagram of an array controller coupled with a SBAR component wherein the performance optimization component is peripherally located to the array controller;

FIG. 5 illustrates a storage array system according to an exemplary embodiment wherein one SBAR component is coupled with a plurality of array controllers;

FIG. 6 illustrates a system in which a plurality of SBAR components provide a plurality of host processing systems with access to multiple storage arrays; and

FIG. 7 illustrates a computing system in which a number of SBAR components provide a plurality of host processing systems with access to multiple storage arrays.

### DETAILED DESCRIPTION OF THE INVENTION

Reference will now be made in detail to the presently preferred embodiments of the invention, examples of which are illustrated in the accompanying drawings. The SBAR provides for the configuration of an array controller of a storage array for optimizing the performance of the storage array for a given application. The present invention provides an adaptive performance tuning capability which is based on the end-user application within the array controller. This increases the reliability of application performance through the allocation of appropriate array controller resources for the application. The SBAR provides configuration profiles which are made available within the array controller, thereby, optimizing the controller in an application-oriented configuration. The configuration profiles are standardized which assists in the provision of user support.

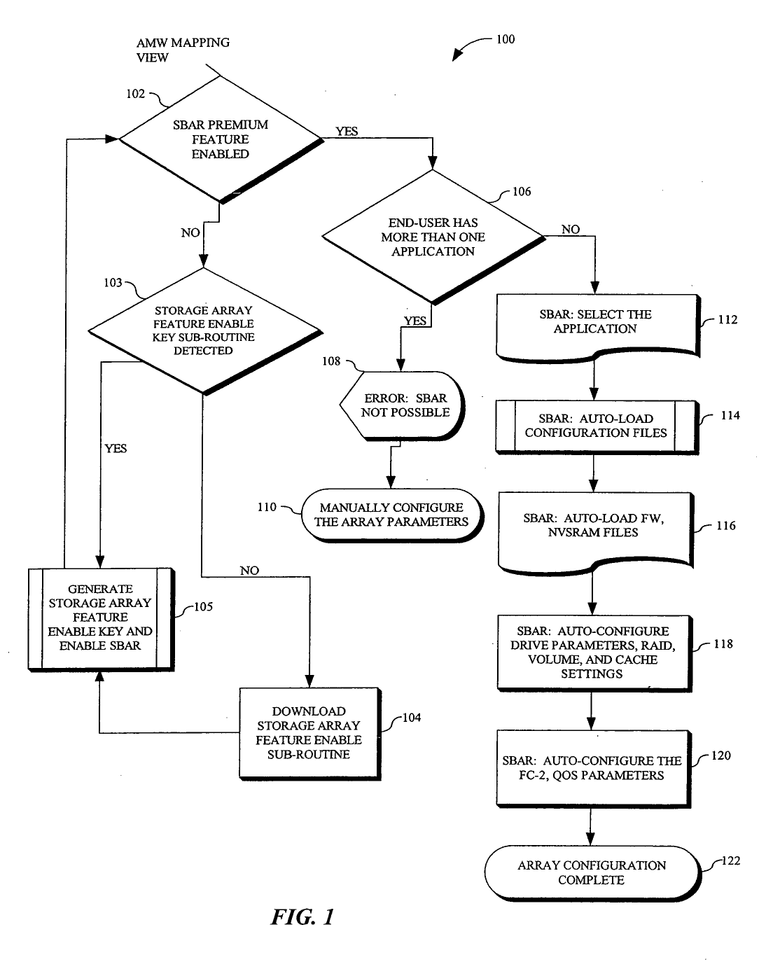

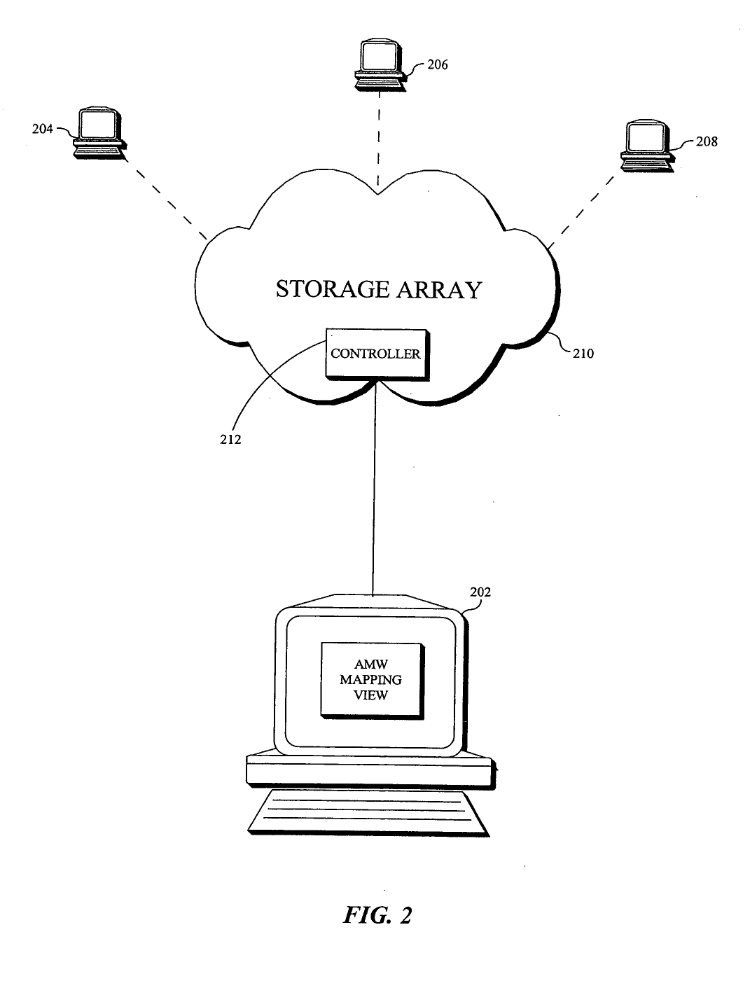

Referring now to FIG. 1, an exemplary method 100 optimizing the performance of an application is shown. In a preferred embodiment, the present invention is a software program executed by an array controller, communicatively coupled with at least one host (computing) system, of a storage array within a storage area network (SAN) environment. Alternatively, the method 100 may be executed from the host (computing) system communicatively coupled with the array controller or from various alternative information handling systems connected within the SAN environment. A Storage Area Network (SAN) may include one or more array controllers (e.g., servers) with host adapters residing within for communicatively coupling with the host system, a switch and storage arrays interconnected via various industry standard communication protocols, such as Fibre Channel, Fibre Channel 2, Small Computer Systems Interface (SCSI), Enterprise System Connection (ESCON), a registered trademark of International Business Machines, and the like. The connections may be established using serial cable, optical cable, infrared technology, and the like. As shown in FIG. 2, the SAN may further include a plurality of host systems 202, 204, 206, and 208, communicatively coupled with the storage array 210 via the array controller 212. It is contemplated that an Ethernet Hub may be included within the storage array or array controller which may form a public network and uplink with a Local Area Network (LAN), which may include a Virtual Local Area Network (VLAN). The host system(s), Ehternet Hub and LAN may be connected within the SAN via a network connection, which may be established using industry standard protocols such as those identified above. The host system(s) may be connected directly to the array controller or to a switch of the array controller via a Fibre Channel link and storage arrays via serial connections. In embodiments of the invention, the storage arrays may include at least one array controller and drive enclosures providing data storage. In a preferred embodiment, the drive enclosures of the storage arrays contain disk drives and the array controllers are disk array controllers. For example, the storage array may be established using a redundant array of independent/inexpensive disks (RAID) system. However, other storage system technologies such as tape array storage, network array storage (NAS), and the like, may be employed without departing from the spirit and scope of the present invention.

It is contemplated that the controllers (servers) may employ a variety of operating systems (OS), for example, Windows 2000, Windows 2003, Windows NT, Solaris, Netware, IRIX, HP-UX, Linux, AIX and the like. The controller (servers) may each employ the same operating system or may each employ a different operating system forming a heterogeneous environment. Further, the present invention is operable across various storage array environments. For example, one storage array may be configured in a first RAID configuration (i.e., RAID-0, RAID-1, RAID-3, or RAID-5) while a second storage array may be configured in a second RAID configuration, which may be the same as or different from the RAID configuration of the first storage array. Alternatively, a first storage array may be configured as a RAID while a second storage array may be configured as just a bunch of disks (JBOD).

Host adapters, switches, hubs and array controllers may be connected by the various protocols, such as Fibre Channel, Fibre Channel 2, serial cable, ESCON, and the like. Passive connectivity components, such as, Giga-Bit Interface Converters (GBICS), connectors, device ports and the like may also be employed. It is contemplated that other connectivity components may be employed by one of ordinary skill in the art without departing from the scope and spirit of the present invention.

The method 100 provides for the configuration of the parameters of a storage array, which may yield an increase in performance of a selected application. By building an adaptive performance tuning, within the array controller, based on the end-user application, the present invention may provide for the proper allocation of controller resources for a particular application. In a preferred embodiment, the configuring of the parameters of the storage array occurs automatically via the execution of the instruction set contained in the software program of the present invention.

Storage array parameters may include the RAID level, configuration of the Non-Volatile Static Random Access Memory (NVSRAM), and Fibre Channel (FC) level (i.e., FC-2 class) Quality of Service (QOS) parameters. Thus, the present invention may provide FC protocol level support as per application-oriented requirements. Further, the drive related parameters, such as optimum size of the drive based upon the application requirements, queue depth, input/output (I/O) size, and the like, may be optimized. Additionally, the host OS specific parameters within the NVSRAM area on the array and logical volume parameters (segment size, cache multiplier, etc.,) may be optimized by the present invention.

Applications may typically include database, multimedia, web pages, streaming video, and the like. It is understood that various other applications as contemplated by those of ordinary skill in the art may be installed and executed without departing from the scope and spirit of the present invention.

In a preferred embodiment, the method 100 is executed in conjunction with access to the storage array, via the controller communicatively coupled with the host system, through the array management window (AMW) or alternatively, the enterprise management window (EMW) of the array management software. In step 102 it is determined if the SAN Based Application Recognition (SBAR) feature (array self-configuration wizard) may be enabled. Whether the SBAR is allowed to execute its self-optimizing program routine may be dependent on several matters. If the SBAR feature is not enabled to execute its programming, then in step 103 it is determined whether a Storage Array Feature Enable (SAFE) key sub-routine is detected. If the SAFE key sub-routine is detected, then in step 105, a SAFE key is generated by the key generation utility. If the SAFE key sub-routine is not detected in step 103, then in step 104 a SAFE key sub-routine is downloaded. It is understood that the SAFE key generation utility is a stand-alone software application that may be supplied to the end-user. It is further contemplated that the SAFE key generation utility may be incorporated with the SBAR. After the SAFE key sub-routine is downloaded in step 104, then in step 105 a SAFE key is generated by the key generation utility.

In a preferred embodiment, step 105 is a sub-routine which may be downloaded into the controller by the array management software system for the array controller of the SAN. For example, SANtricity, a registered trademark of LSI Logic Corporation, which provides a software based controller management protocol may include a Storage Array Feature Enable (SAFE) key sub-routine which may include SBAR as an additional feature for manipulating the method in 100. It is understood that the SAFE key sub-routine, may be variously configured as contemplated by those of ordinary skill in the art. After the key is generated in step 104, SBAR may be enabled.

After the generation of the key, in step 105, or if it is determined that no key need be generated in step 102, then the method proceeds to step 106 where a determination is made as to the application(s), such as those identified previously, selected by an end-user. If it is determined in step 106 that more than one application has been selected by the end-user, then the method proceeds to step 108 where an error message, identifying that SBAR is not possible, is displayed to the end-user. After the error message of step 108 is displayed the method, in step 110, may allow for the manual configuration of the array parameters, as described above. If step 106 results in a determination that the end-user does not have more than one application being executed, the method proceeds to step 112 where the SBAR selects the application. The selection of the application by the SBAR invokes the execution of a sub-routine which automatically selects and loads a configuration profile tailor-made for that application in step 114. In a preferred embodiment, the configuration profile is pre-created and installed/loaded upon the controller (preferably within the controller flash memory) along with the controller management software. Thus, the present invention provides standard configuration profiles which may be automatically loaded and made available within numerous array controller environments. This standardization of configuration profiles may assist in the providing of assistance to the end-user when less than optimum conditions are experienced with the SAN environment. Next, the end-user is prompted to load appropriate controller firmware and NVSRAM files, in step 116, to suit the application and the end-user (OEM/open-market). In a preferred embodiment, the user configurable options on the NVSRAM are loaded/installed along with the configuration profile allowing the present invention to load the proper options to suit the application. It is understood that numerous pre-created configuration profiles, directed to various applications which may be executed within the SAN, may be installed. Alternatively, the configuration profiles for various applications may be created and stored on various computer readable mediums and then loaded individually within the controller in order to accommodate the needs of the end-user. Additionally, the user configurable options for the NVSRAM may be separately installed from the configuration profile.

In step 118, the SBAR configures various specific settings for the array, such as the drive parameters, volume(s), RAID level, cache settings (write-back or write-through) that are appropriate for audio/video applications, and segment size which are based on and appropriate for the application. Then in step 120 the SBAR configures the Fibre Channel (FC) protocols along with the quality of service (QOS) parameters based upon the SAN data requirements. In a preferred embodiment, the FC protocol is an FC-2 class of service. After the FC class of service and QOS parameters are appropriately configured for the detected application, in step 122 the array configuration completes.

It is understood that the controller firmware has the ability to hold multiple firmware images in a flash memory region appropriate for various applications (through staged online firmware download) to be available for loading by the array self-configuration wizard and that the array management software is able to maintain several default configuration profiles to suit the various applications. The SBAR may provide a firmware download to suit the application environment using a staged online firmware download feature. Further, the FC-2 class of service and QOS parameters may be alterable by the array self-configuration wizard based on the detected application. It is contemplated that the implementation of multiple FC classes of service may require changes within the controller firmware. These changes, as contemplated by those of ordinary skill in the art, may be made without departing from the scope and spirit of the present invention.

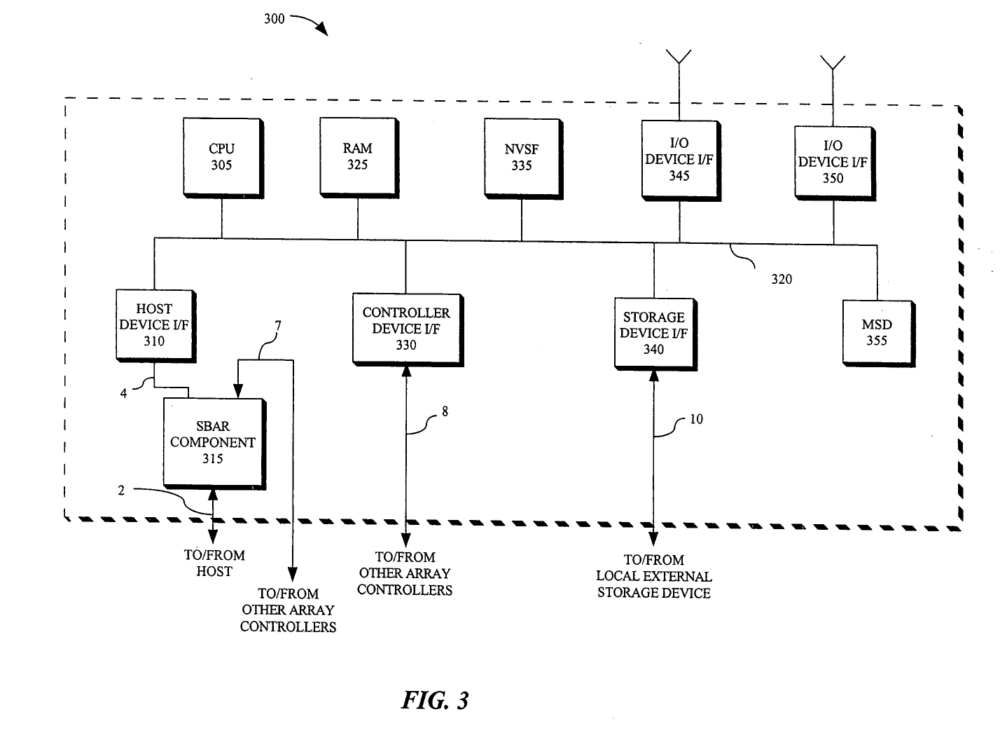

It is contemplated that the SBAR may be implemented from a component feature of an array controller as shown in FIG. 3. FIG. 3 illustrates the hardware architecture of an array controller 300 of the present invention according to one embodiment. A central processing unit 305 is coupled via a bus 320 with a host device interface 310 which is coupled to an SBAR component via communication link 4. Array controller 300 further includes a random access memory (RAM) 325, a non-volatile storage facility (NVSF) 335, a mass storage device (MSD) 355, each of which is coupled to the bus 320. Bus 320 may represent multiple physical or logical buses, which may be interconnected by various adapters and/or controllers. NVSF 335 may be, or may include, a non-volatile static random access memory (NVSRAM), a read-only memory (ROM), a programmable read-only memory (PROM), an electrically erasable programmable read-only memory (EEPROM) and the like. MSD 355 may be any conventional device that is suitable for non-volatile storage of large volumes of data such as a magnetic disk or tape, an optical storage device such as CD-ROM (Compact Disc-ROM), CD-R (CD-recordable), DVD (Digital Versatile Disc), a magneto-optical (MO) device and the like. A storage device interface 340, a controller device interface 330 and input/output (I/O) device interfaces 345 and 350, may also be coupled to bus 320. I/O device interfaces 345 and 350 may also couple with separate, external connectors on array controller 300.

In the preferred embodiment SBAR component 315 is embedded in array controller 300. The SBAR 315 includes the self-configuration wizard which optimizes the configuration of the storage array for the performance of an application. Consequently, SBAR component 315 connects communication path 2 to array controller 300, which enables a host system to be connected to array controller 300. It may be contemplated that host device interface 305 may connect a host system directly to array controller 300 and then connect a communication path to SBAR component 315. In such an instance bus 320 would be connected to SBAR component 315.

In the present embodiment SBAR component 315 is also coupled to a separate, external connector on array controller 300, which connects communication path 6 to SBAR component 315. Communication path 6 may connect other array controllers to SBAR component 315. Consequently, other array controllers may be locally or remotely located with respect to array controller 300 in which SBAR component 315 is embedded. The connector for communication path 6 may be an Ethernet, ATM, T1, T3, FDDI adapter or any other suitable device, depending upon the nature of communication path 6. Controller device interface 330 connects communication path 8 to bus 320 in order to connect a remote array controller(s). Controller device interface 330 may be an Ethernet, ATM, T1, T3, FDDI adapter or any other suitable device, depending upon the nature of the communication path 8. Storage device interface 340 connects communication path 10 to bus 320 in order to connect external storage devices. Storage device interface 340 may be an Ethernet, ATM, T1, T3, FDDI adapter or any other suitable device, depending upon the nature of the communication path 10.

I/O device interfaces 345 and 350 may be used to connect a keyboard and a monitor to bus 320. I/O interface 345 and 350 may therefore be used by a systems administrator to perform various functions, such as initially configuring array controller 300, inputting commands and control information (i.e., loading configuration profiles) to array controller 300 or obtaining status information from array controller 300. Further, these interfaces 345 and 350 can be used to remotely perform these same functions on a remote array controller via (local) array controller 300 and communication path 8.

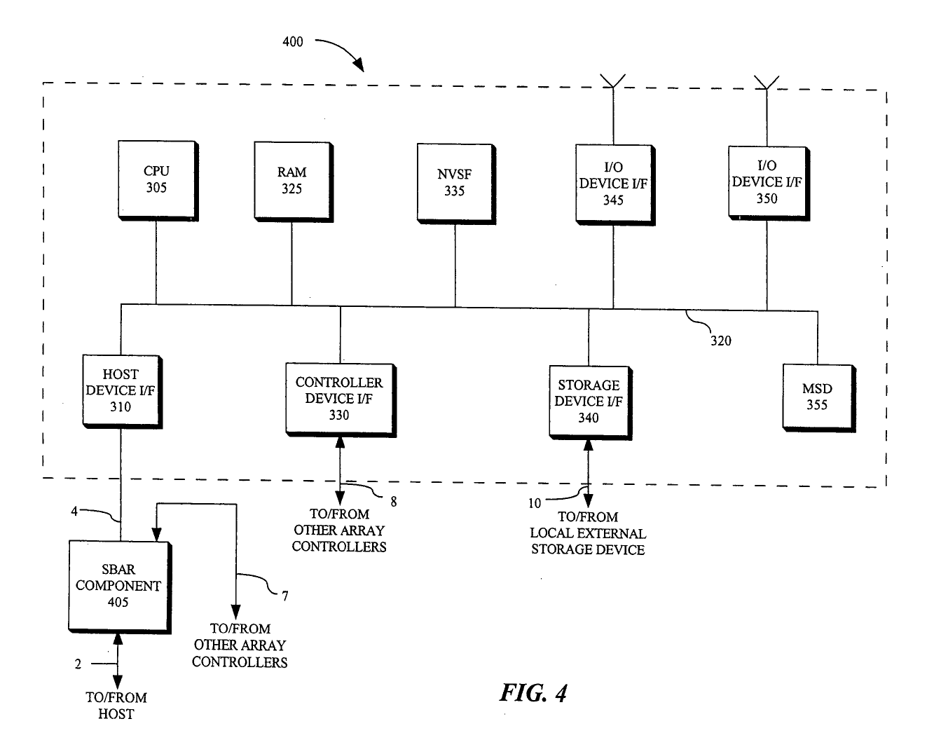

FIG. 4 generally illustrates the array controller described in FIG. 3 except that in this preferred embodiment the SBAR component is an SBAR component enclosure 405 and is located externally of array controller 400. The ability to place SBAR component enclosure 405 remote to array controller 400 provides a measure of facility protection. Further, it potentially eliminates electrical coupling among the host system and array controller 400. This provides another measure of protection.

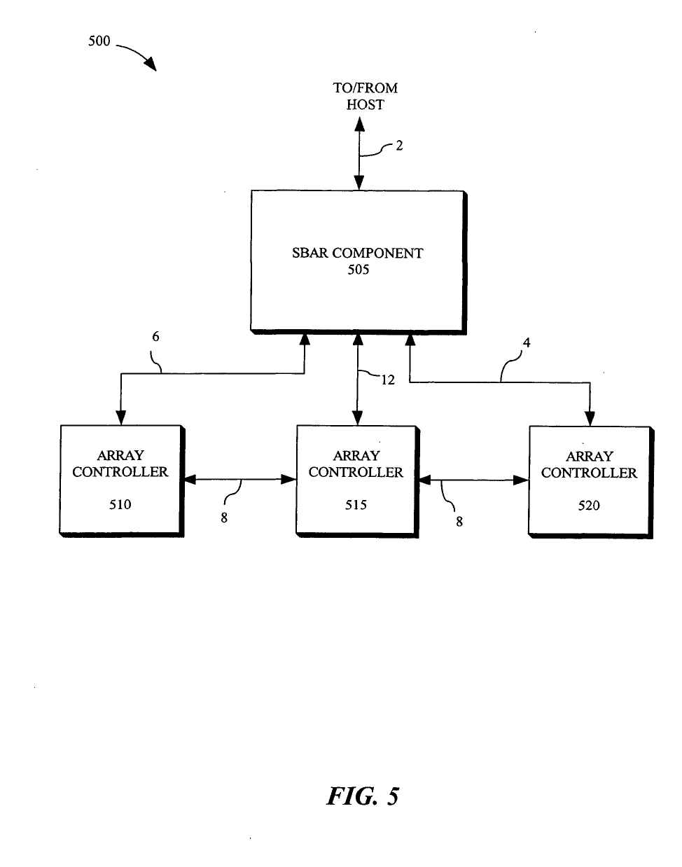

FIG. 5 illustrates an SBAR component 505 with multiple output interfaces connecting multiple communication paths 4, 6 and 12. These communication paths connect multiple array controllers 510, 515, and 520. It is contemplated that any number of output interfaces may be included within SBAR component 505 connecting any number of array controllers. SBAR component 505 may also be embedded SBAR component 315, as shown and described in FIG. 3. Array controller 300, of FIG. 3, may include any number of separate, external connectors, which can couple any number of other array controllers to SBAR component 315.

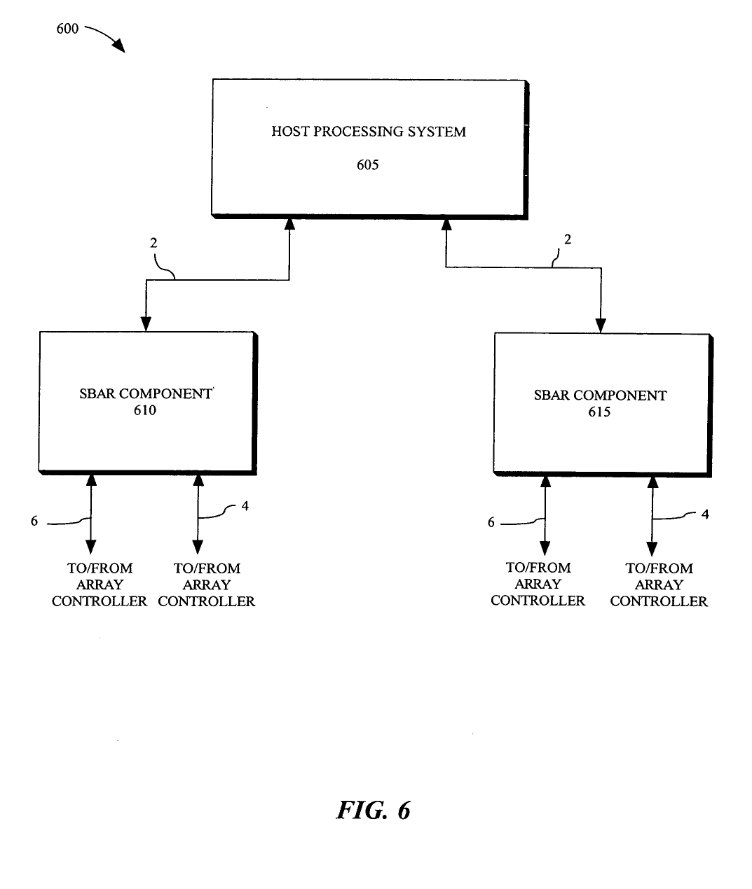

FIG. 6 illustrates a computing system 600 in which multiple SBAR component enclosures 610 and 615 are connected to a single host system 605 with multiple host ports. Communication path 2 connects multiple SBAR component enclosures 610 and 615 with the host system 605. The connector for communication path 2 may be an Ethernet, ATM, T1, T3, FDDI adapter or any other suitable device, depending upon the nature of communication path 2. Any number of SBAR component enclosures may be connected to a host system. They may be connected in a daisy chain configuration or another configuration as contemplated by one of ordinary skill in the art. Communication path 4 and communication path 6 connect the SBAR component enclosures 610 and 615 with one or more array controllers.

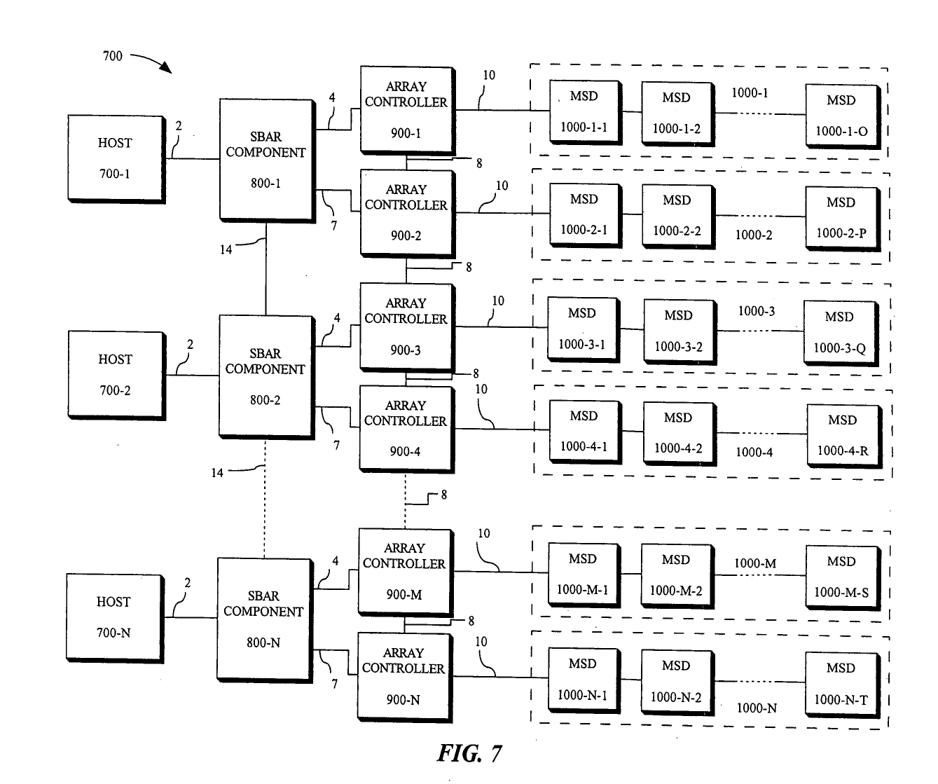

FIG. 7 illustrates a computing system in which a plurality of SBAR component enclosures of the present invention provides a plurality of host systems with access to a plurality of storage arrays. Specifically, the computing system includes N host systems, 700-1 through 700-N, which are coupled to N SBAR components 800-1 through 800-N, respectively. The computing system further includes N array controllers, 900-1 through 900-N, which are coupled to SBAR components 800-1 through 800-N, respectively; and N storage arrays, 1000-1 through 1000-N, which are coupled to array controllers, 900-1 through 900-N, respectively. Each of the storage arrays includes a number of mass storage devices (MSDs) coupled to a array controller in a daisy chain configuration. Specifically, storage array 1000-1 includes O MSDs, 1000-1-1 through 1000-1-O; storage array 1000-2 includes P MSDs, 1000-2-1 through 1000-2-P; storage array 1000-3 includes Q MSDs, 1000-3-1 through 1000-3-Q; storage array 1000-4 includes R MSDs, 1000-4-1 through 1000-4-R; storage array 1000-M includes M MSDs, 1000-M-1 through 1000-M-S; and storage array 1000-N includes N MSDs, 1000-N-1 through 1000-N-T.

The data communication paths 2, 4, 6, 8, 10 and 14 may actually include two or more redundant, physical paths. Therefore, a failure of any single physical connection does not affect the ability to access any stored data. Communication pathways 2, 4, 6, 8, 10 and 14 in other embodiments, may be configured for a variety of protocols and standards, such as serial SCSI, Fiber Channel, DAFS (direct access file system), CIFS (common internet file system/services), AppleTalk, Netware, NFS (networked file system), ESCON (enterprise system connection) and the like. Communication pathway 12, as discussed in FIG. 5, may also be configured for a similar variety of protocols and standards.

The host systems identified and described throughout the instant specification may be any conventional information handling system such as a personal computer, a mini-computer, a mainframe and the like. In addition, the host systems may function as a server for one or more client information handling systems (not shown).

Each MSD may include a non-volatile facility for storing large volumes of data, such as a magnetic disk or tape, an optical storage device such as CD-ROM (Compact Disc-ROM), CD-R (CD-recordable), DVD (Digital Versatile Disc), a magneto-optical (MO) device and the like. The MSDs within the computing system need not be of the same device type. That is, the MSDs in any given storage array may use a different type of storage medium from those in any other storage array.

Each storage array may be located geographically distant from the other storage arrays. With respect to a given (local) SBAR component, any or all of the other (remote) SBAR components and array controllers, host systems, and storage arrays may therefore be located at distant locations to the local array controller.

Each SBAR component communicates with its local host system, array controller and storage array utilizing standard SCSI (Small Computer Systems Interface) protocols. Consequently, operation of a SBAR component of the present invention in the manner described herein is not dependent upon the particular hardware of software configuration of any local host system, array controller, or storage array, as long as those devices are SCSI-compatible. However, the data communication links 2, 4, 6, 8, 10 and 14 may conform to other protocols and standards, such as serial SCSI, Fiber Channel, ESCON and the like. Thus, because data communication links 2, 4, 6, 8, 10 and 14 are conventional interfaces, a SBAR component of the present invention can be used concurrently with host systems, array controllers, and MSDs having different configurations. For instance, one host system in the SAN may be a mainframe computer while another host system is a personal computer. Similarly, one storage array in the system may include conventional magnetic hard disk drives while another storage array includes CD-ROM drives. Further, the array controllers themselves may be of dissimilar configuration in order to accommodate the different storage arrays.

The SBAR components, communicatively linked, operate in peer-to-peer relationships with each other when responding to the operational environment. For instance, any SBAR component can be designated as the local system. Meaning that in the case of failure of the original local SBAR component another, which is communicatively linked can take over its functions permanently or until repairs are made and the original is functioning properly again.

The present invention is not limited to the specific configuration shown in FIG. 7. For example, the system configuration might alternatively include only a single host system, which is coupled to multiple geographically separated SBAR components. The SBAR components may be a mixture of embedded SBAR component within a array controller and separate SBAR component enclosures. It may be contemplated that the array controller may have a direct link to the host system and then route the data through the SBAR component. Other configurations as contemplated by one of ordinary skill in the art do not depart from the spirit and scope of the present invention.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A computer readable set of instructions, for optimizing performance of an application by a storage array, comprising:
a first command for detecting an application selected by an end-user; and
a second command for establishing a configuration profile of the storage array based on the detected application;
wherein the configuration profile establishes storage array parameters for optimal performance of the end-user selected application.

2. The computer readable set of instructions of claim 1, further comprising a third command for generating a key.

3. The computer readable set of instructions of claim 1, wherein the first and second commands are loaded upon an array controller of the storage array.

4. The computer readable set of instructions of claim 1, wherein the configuration profile may be selected from a plurality of pre-built configuration profiles.

5. The computer readable set of instructions of claim 1, wherein the computer readable set of instructions is included within a storage array management software program.

6. The computer readable set of instructions of claim 1, wherein the storage array comprises a RAID array.

7. The computer readable set of instructions of claim 1, further comprising an enclosure for housing a computer readable medium which is loaded with the computer readable set of instructions.

8. The computer readable set of instructions of claim 1, wherein the parameters of the storage array include selection of a RAID level.

9. The computer readable set of instructions of claim 1, wherein the parameters of the storage array include selection of fibre channel class of service and quality of service parameters.

10. The computer readable set of instructions of claim 1, wherein the parameters of the storage array include configuring the firmware of the storage array.

11. A computer readable set of instructions, for optimizing performance of an application by a storage array having a controller, comprising:
a first command for generating a key, the key for enabling the performance of the computer readable set of instructions;
a second command for detecting an application selected by an end-user; and
a third command for establishing a configuration profile of the storage array based on the detected application;
wherein the configuration profile establishes storage array parameters for optimal performance of the end-user selected application.

12. The computer readable set of instructions of claim 11, wherein the commands are loaded upon an array controller of the storage array.

13. The computer readable set of instructions of claim 11, wherein the configuration profile may be selected from a plurality of pre-built configuration profiles.

14. The computer readable set of instructions of claim 11, wherein the computer readable set of instructions is included within a storage array management software program.

15. The computer readable set of instructions of claim 11, wherein the storage array comprises a RAID array.

16. The computer readable set of instructions of claim 11, further comprising an enclosure for housing a computer readable medium which is loaded with the computer readable set of instructions.

17. The computer readable set of instructions of claim 11, wherein the parameters of the storage array include selection of a RAID level.

18. The computer readable set of instructions of claim 11, wherein the parameters of the storage array include selection of fibre channel class of service and quality of service parameters.

19. The computer readable set of instructions of claim 11, wherein the parameters of the storage array include configuring the firmware of the storage array.

20. A storage array based application recognition system for a storage array, comprising:
an enclosure housing a computer readable medium, the computer readable medium communicatively coupled with an array controller, the computer readable medium further comprising,
a first command for detecting an application selected by a user of the storage array; and
a second command for establishing a configuration profile of the storage array based on the detected application;
wherein the configuration profile establishes storage array parameters for optimal performance of the end-user selected application.

21. The storage array based application recognition system of claim 20, wherein the enclosure is remote from the array controller.

22. The storage array based application recognition system of claim 20, wherein the enclosure is disposed within the array controller.

23. The storage array based application recognition system of claim 20, wherein the computer readable medium further includes a command for generating a key.

24. A method of optimizing performance of an application from a storage array, comprising:
detecting the application selected by a user of the storage array; and
configuring storage array parameters based on the detected application for optimizing performance of the application.

25. The method of claim 24, further comprising the step of generating a key.

26. The method of claim 24, further comprising selecting at least one configuration profile pre-built with storage array parameter settings and loaded within the firmware of the storage array.
